(19) United States
(12) Patent Application Publication
(10) Pub. No.: US 2011/0040793 A1
(43) Pub. Date: Feb. 17, 2011

(54) Administration Groups

(76) Inventors: Mark Davidson, Scotts Valley, CA (US); Viswanadh Addala, Campbell, CA (US); Jonathan Thatcher, Mountain View, CA (US); Kevin Nathanson, Castro Valley, CA (US)

Correspondence Address: FISH & RICHARDSON P.C., PO BOX 1022, MINNEAPOLIS, MN, 55440-1022, US

(21) Appl. No.: 12/539,911

(22) Filed: Aug. 12, 2009

(51) Int. Cl. G06F 17/30

(52) U.S. Cl. 707/784; 707/E17.005

(57) ABSTRACT

Methods, program products, and systems for managing database access privileges using administration groups are described. Administrative functions for managing a database server and administrative functions for managing collections of databases can be separated. Groups of databases can be created on the database server. Tasks for adding and managing multiple databases can be delegated from a server administrator to one or more group administrators who can manage one or more groups of databases. The groups of databases can be stored in various home folders, each home folder corresponding to a group. Management rights on the databases can be determined by the home folders in which the databases are located.

### TECHNICAL FIELD

This disclosure relates generally to database management.

### BACKGROUND

A modern database application server can host multiple databases. Administering the server and administering the databases can involve different administrators and administrative tasks. A server administrator can manage the server. A database administrator can manage one or more of the databases. In a large organization (e.g., a company), a group (e.g., a department) can maintain multiple databases. New databases can be created, and old ones removed. Because the database administrator manages only the databases on which the database administrator already has privileges to manage, the database administrator may not have sufficient privileges to create a new database. The task for creating new databases therefore falls on the server administrator. In the large organization scenario, the server administrator can be overburdened when the database administrator is required to manage databases for multiple groups and database administrators. Giving every database administrator server administration privileges can lead to undesirable administrative rights that may be a security concern.

### SUMMARY

Methods, program products, and systems for managing database access privileges using administration groups are described. Administrative functions for managing a database server and administrative functions for managing collections of databases on the server can be separated. Groups of databases can be created on the database server. Tasks for adding and managing multiple databases can be delegated from a server administrator to one or more group administrators, who manage one or more groups of databases. The groups of databases can be stored in various home folders, each home folder corresponding to a group. Management rights on the databases can be determined by the home folders in which the databases are located.

Delegating the tasks can include creating administration groups for managing individual databases located in each administration group. The group administrator can administer one or more administration groups. A home folder can be defined for each administration group. The administration group can have specific access and operative privileges on databases within the folder. A user can be designated to one or more administration groups as a group administrator. Once designated, an administrator of an administration group, the user can perform database administration tasks on the databases located in the folder corresponding to the administration group.

In some implementations, authentication of group administrators can be managed by an external account management system. The group administrator's name, password, and membership can be managed outside a database management context. Thus, for example, a standard corporate user account system can be utilized. A database server administrator is relieved from the tasks of managing user credentials.

Administration groups can be implemented to achieve the following exemplary advantages. Administration groups can provide a way to partition responsibility between server administration and database administration. Administration groups can allow different collections of databases to be managed independently. Administration groups can provide a way to assign or restrict privilege sets, rather than individual access privileges to databases. Administration groups can allow or deny database administration functionality in the user interface based on group privileges, rather than relying on administrative privileges on an entire server. Administration groups can provide an option to use external authentication systems like Open Directory and Active Directory, thereby integrating database user authentication with system (e.g., company wide) user authentication. Administration groups can provide a way to associate a group with a database folder on a file system, as well as a way to change the group database folder, enabling easy file upload and modification. Other advantages will be obvious from the features described below.

The details of one or more implementations of administration groups are set forth in the accompanying drawings and the description below. Other features, aspects, and advantages of administration groups will become apparent from the description, the drawings, and the claims.

### BRIEF DESCRIPTION OF THE DRAWINGS

FIG. 1 is an overview of administration groups.

FIG. 2 is a block diagram illustrating an exemplary system for implementing administration groups.

FIGS. 3A-3C are flowcharts illustrating exemplary processes for creating and using administration groups to determine user access privileges.

FIGS. 4A-4F illustrate exemplary user interfaces for a group administrator.

FIGS. 5A-5D illustrate exemplary user interfaces for a database server administrator.

FIG. 6 is a block diagram of an exemplary system architecture for implementing the features and operations described in reference to FIGS. 1-5.

Like reference symbols in the various drawings indicate like elements.

### DETAILED DESCRIPTION

### Administration Groups Overview

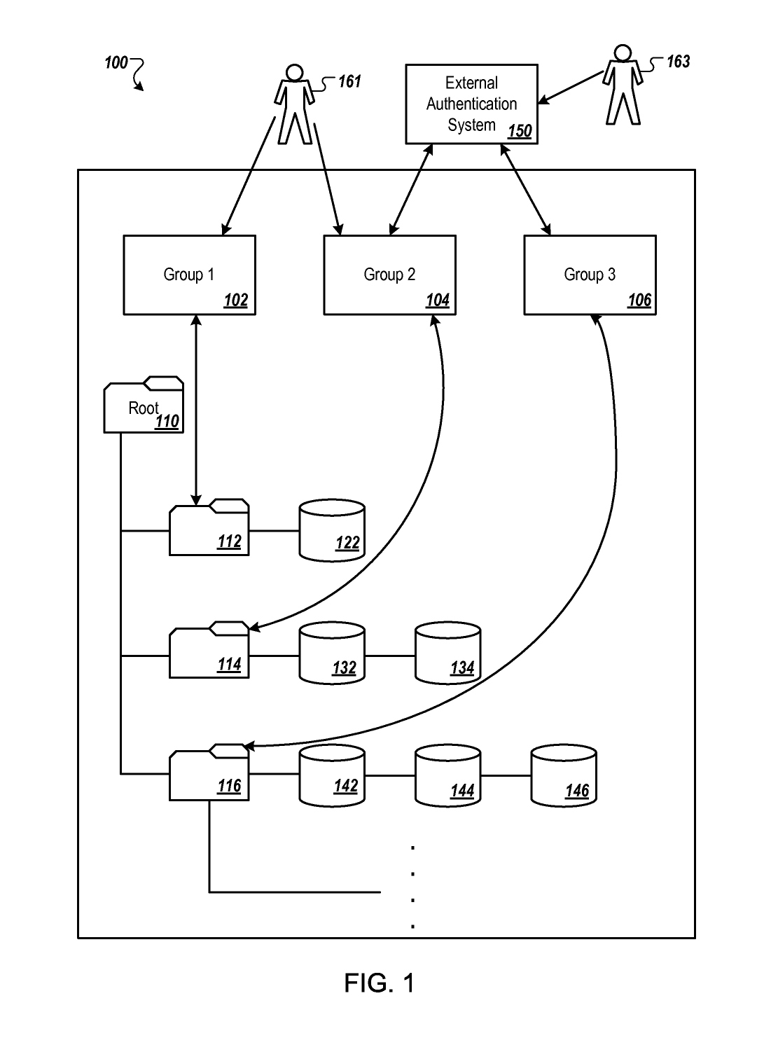

FIG. 1 is an overview of administration groups. For convenience, administration groups will be described with respect to a company (“the Company”) that uses database application system 100.

The Company can have a number of departments, which can include, for example, Finance, Sales, and Development. All the departments can have staff members who create database application programs. The database application programs can include solutions, e.g., one or more databases 122, 132, 134, 142, 144, and 146. The solutions can be hosted on system 100.

A server administrator of system 100 can be responsible for installing and running database application system 100. However, the server administrator does not want to be overburdened by managing and administering individual database solutions from the different departments. Database solution developers (e.g., database application programmers) can administer databases 122, 132, 134, 142, 144, and 146. However, the Company can have policies prohibiting department solution developers from accessing all resources of system 100. Therefore, the server administrator can be the only person who can access server administration functions of system 100.

A solution developer in the Finance department can maintain a “tax policy” database. The solution developer does not have administrator access to system 100, and therefore must contact the server administrator every time the solution developer wants to create a new “tax policy” database (e.g., for upgrading to a new version). The server administrator can be quite busy, and therefore may not be as responsive to the solution developer's requests. The server administrator can delegate some database administration tasks to the solution developer. Administration group features described in this specification can be beneficial in such scenarios.

To use the administration group features, the server administrator can create administration groups 102, 104, and 106. Groups 102, 104, and 106 can model various organizations of the Company (i.e., Finance, Sales, and Development, etc.), or represent some other abstract way to organize sets of databases. Each of the administration groups 102, 104, and 106 can have a home folder 112, 114, and 116, respectively. Databases 122, 132, 134, 142, 144, and 146 can reside in home folders 112, 114, and 116. A home folder (e.g., 112) can correspond to a path in a file system. New database files (e.g., new versions of the “tax policy” database) can be uploaded into file system directories according to the path. Home folders 112, 114, and 116 can be subfolders of root folder 110. Root folder 110 can be a home folder that holds all databases in database application system 100.

The server administrator can give the a group (e.g., group 102) group credentials that can include a group ID (e.g., “Finance”) and a password. The server administrator can give group information (group credentials, home folder path, etc.) to the solution developer. The solution developer can log into an administrative console of the Finance group using the Finance group ID and manage the set of databases (e.g., 122) without further involvement of the server administrator.

Optionally, the server administrator can assign an externally managed “finance” group name to the Finance group 102. Any member of the external “finance” group can administer the Finance group by using the member's external credentials as the login. For example, Joe the solution developer can be a member of the external “finance” group so he can use his user ID and password in the external “finance” group to login to an administrative console and manage the Finance group databases. The details of various implementations of administration groups will be described below.

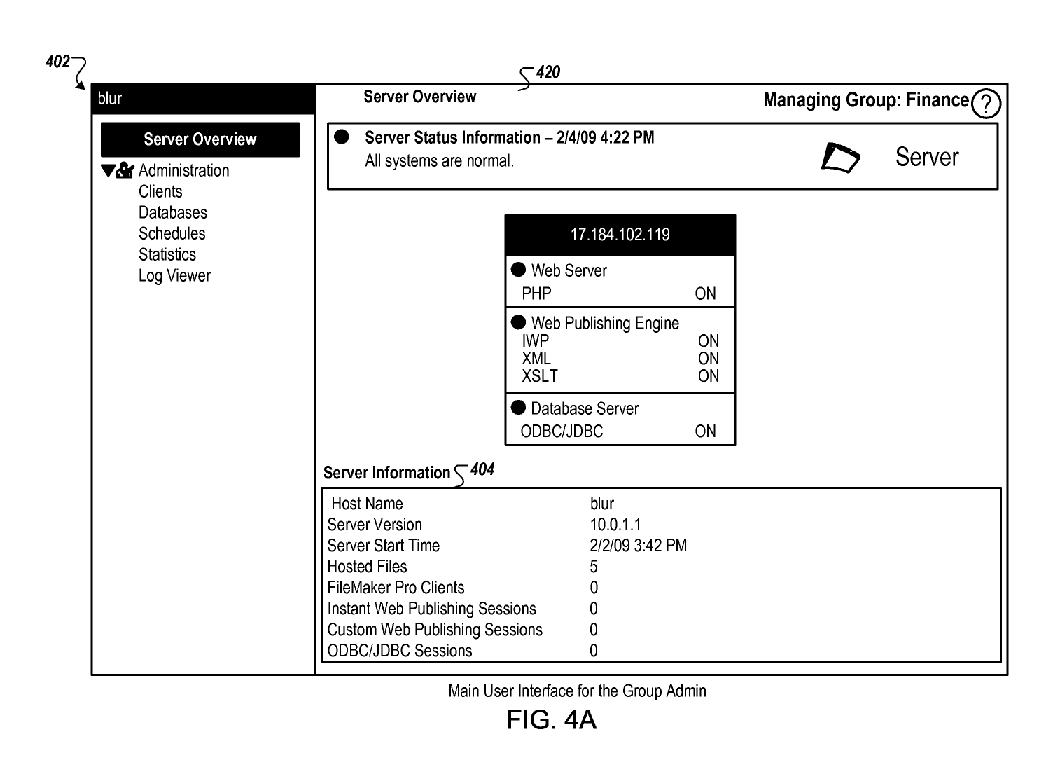

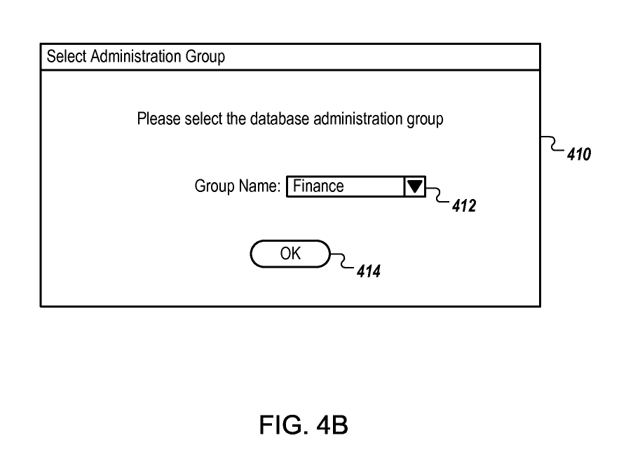

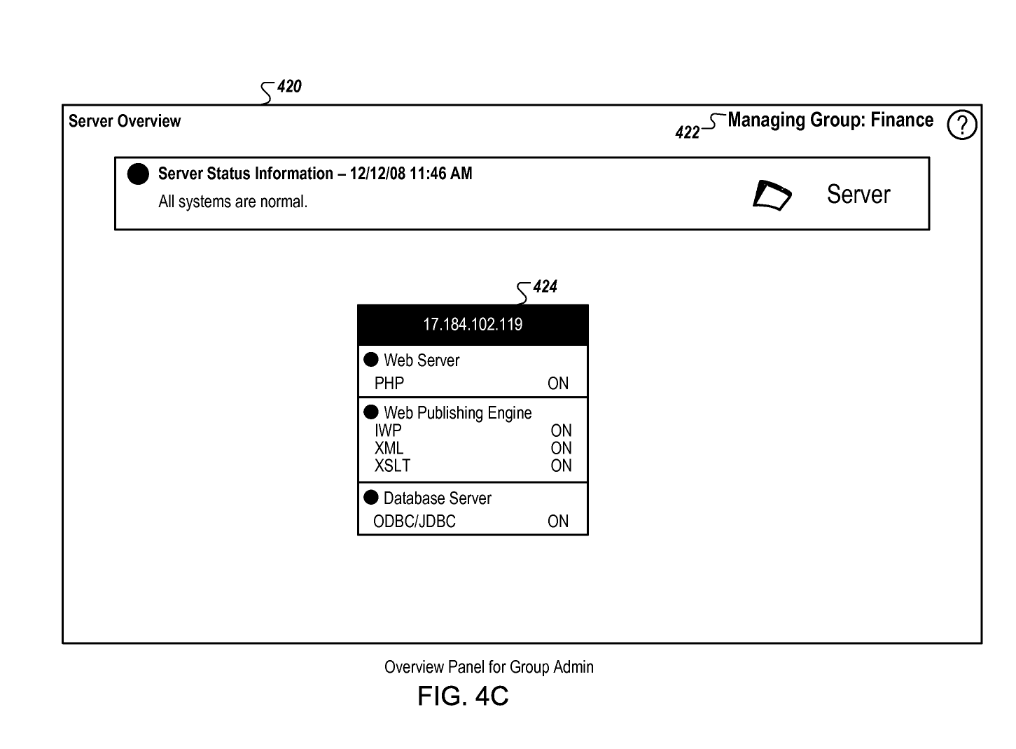

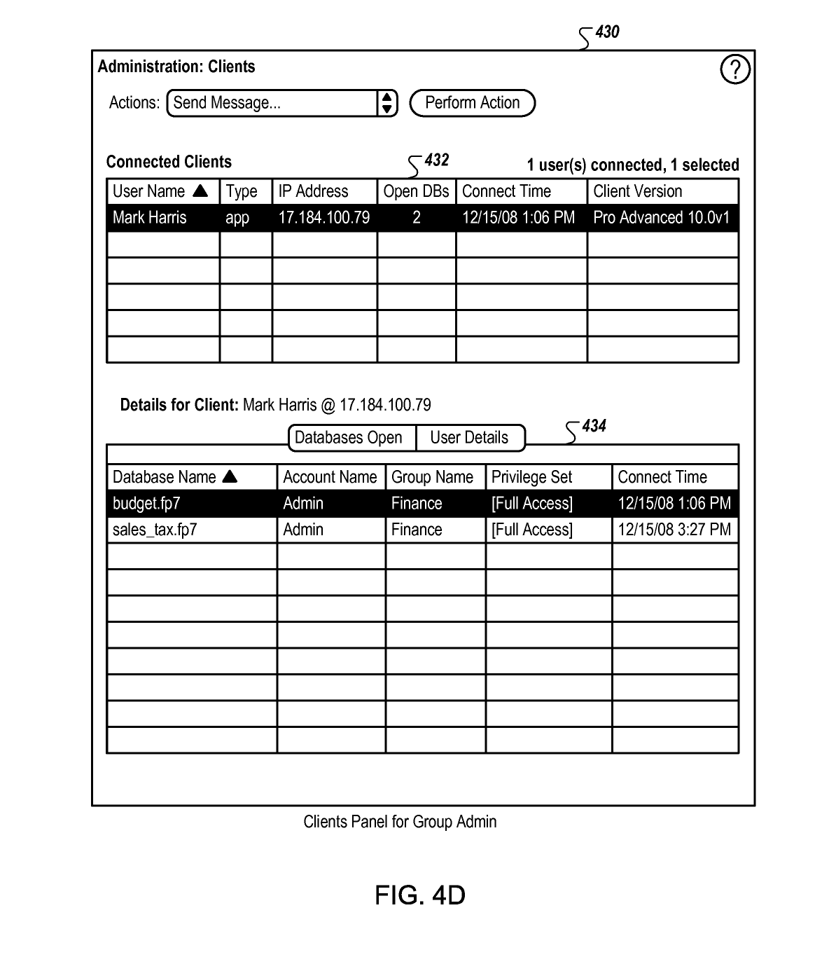

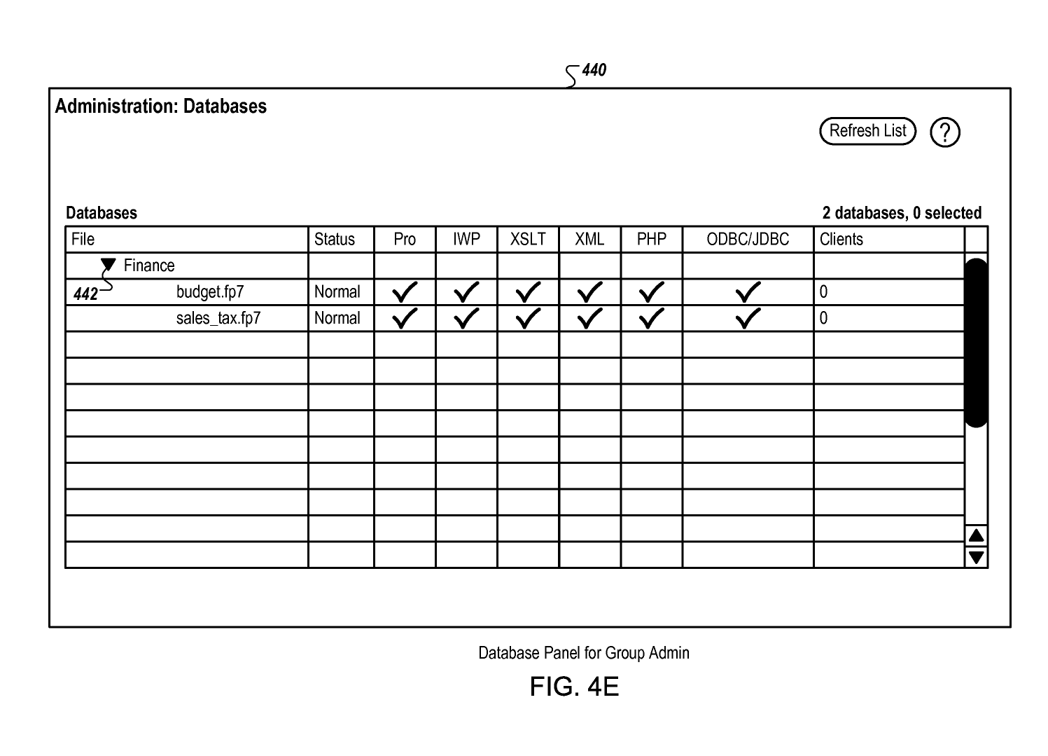

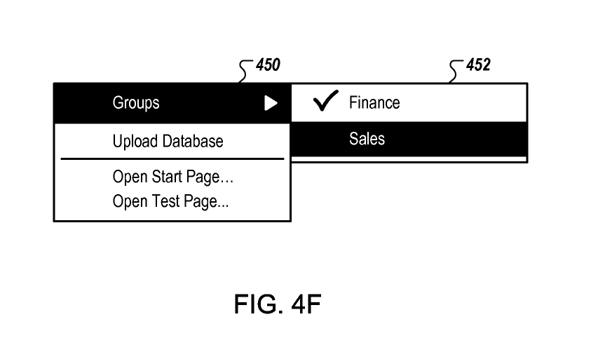

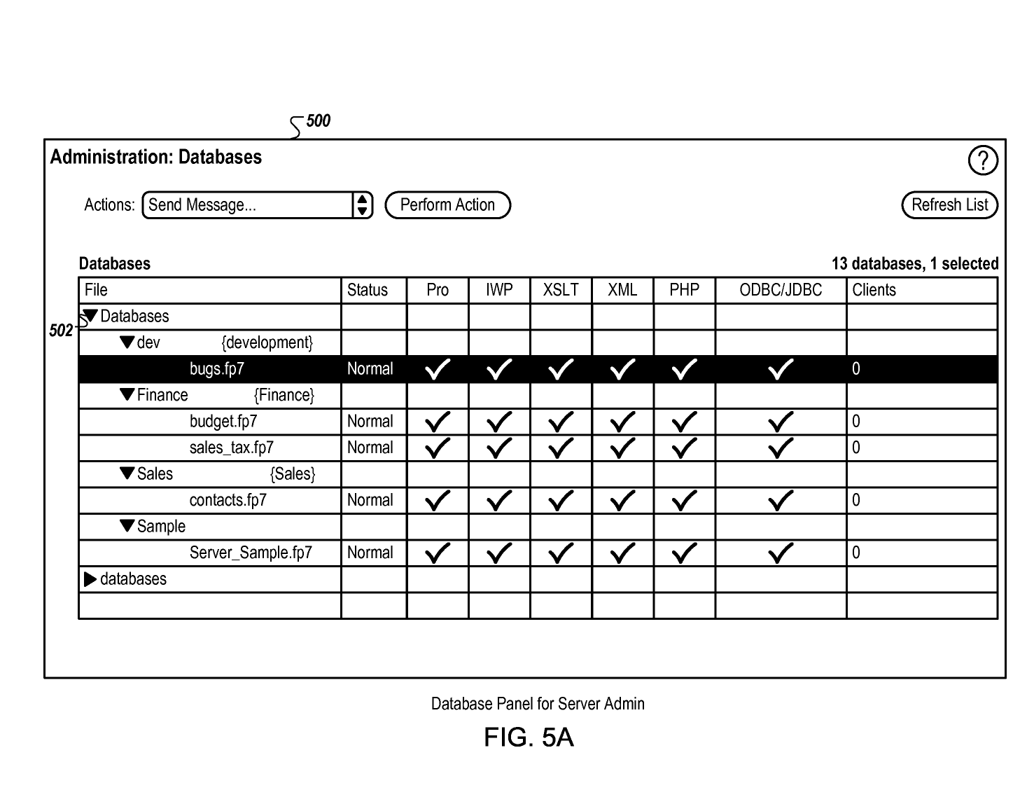

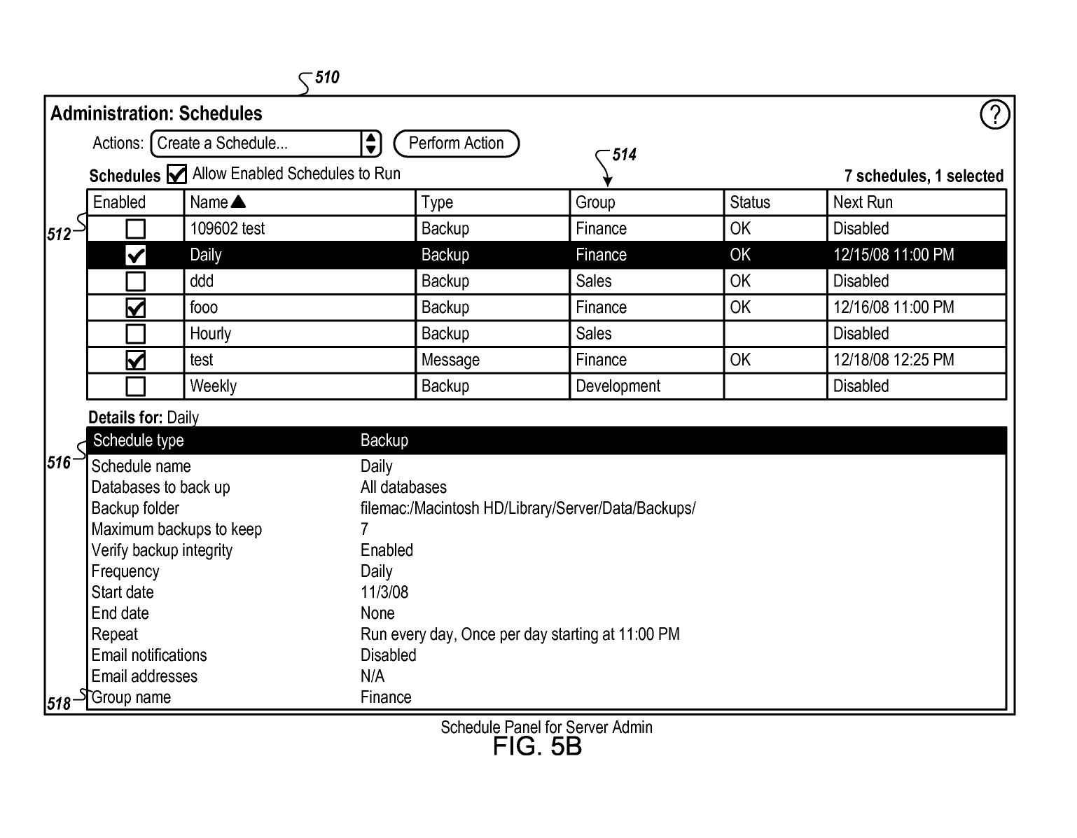

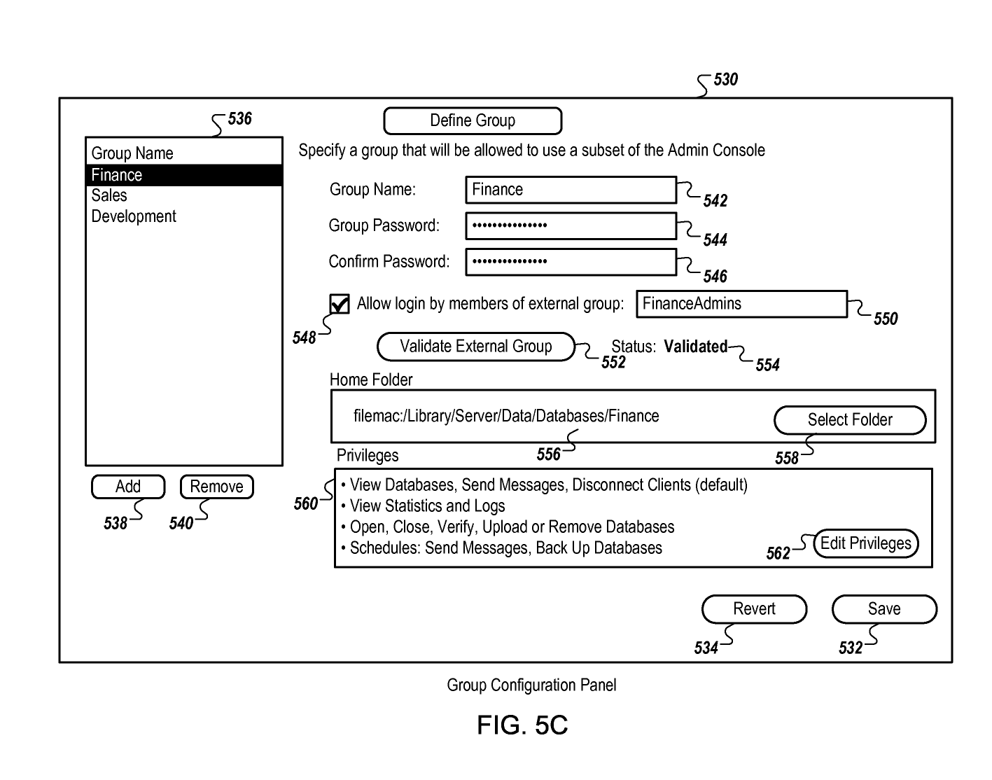

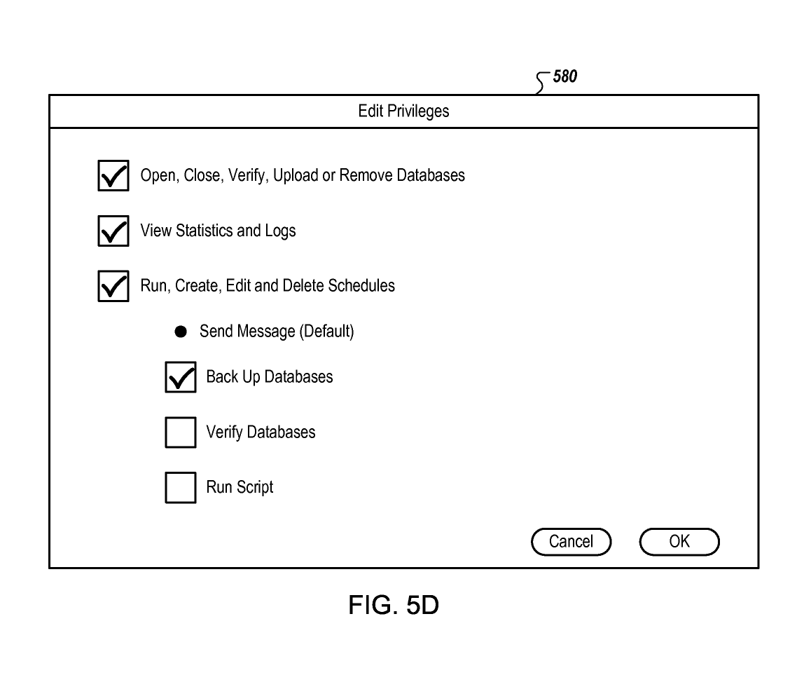

A user interface can be provided for the management of administration groups. The user interface can be used by the server administrator to create and manage the attributes of a group administrator. In a hierarchy of user interfaces of various functions of system 100, various interfaces can be conceptually viewed as nodes in a tree structure in which a user can navigate. The administration group configuration can be viewed as a child node of a general Configuration node of a navigation pane. When selected, the administration group configuration node can present a view that can allow the server administrator to define “database management groups” in an administrative console. More details of the user interface will be described below with respect to FIGS. 4 and 5.

Administration group 102 can have attributes that can include a label (which can act as the group login ID), a password, home folder 112 on a file system, and various privileges. Group administrators 161 and 163 (e.g., solution developers) can manage one or more groups. Group administrators 161 and 163 can differ from a server administrator who can manage the entire database application system 100. Group administrators 161 and 163 can also differ from an end user, who uses databases (e.g., 142, 144, and 146) but does not create or delete databases. The configuration of a group can utilize existing external authentication system 150. Utilize existing external authentication system 150 can enable group administrator 163 to use his own login credential on an external system to gain access to database application system 100.

When group administrator 161 logs into an administrator console, group administrator 161 can get a restricted view of a user interface (compared to a view for a server administrator). Group administrator 161 can have permission to manage databases that have been associated with his groups (e.g., group 102 and group 104) and can be prohibited from executing server administration commands (e.g., start/stop services or edit groups configuration).

Group administrator 161 can perform database operations depending on the privileges granted to the group being administered. All group administrators 161 and 163 can have the access privilege to view databases, send messages, and disconnect database clients. Some of the additional privileges which can be granted can include:
Schedule operations which include creating, editing, deleting and running;
Database operations which include open, closing, verifying, uploading and removing; and
Viewing statistics and logs.

The server admin can perform all operations in the admin console including operations performed on any database.

### Administration Group Functions

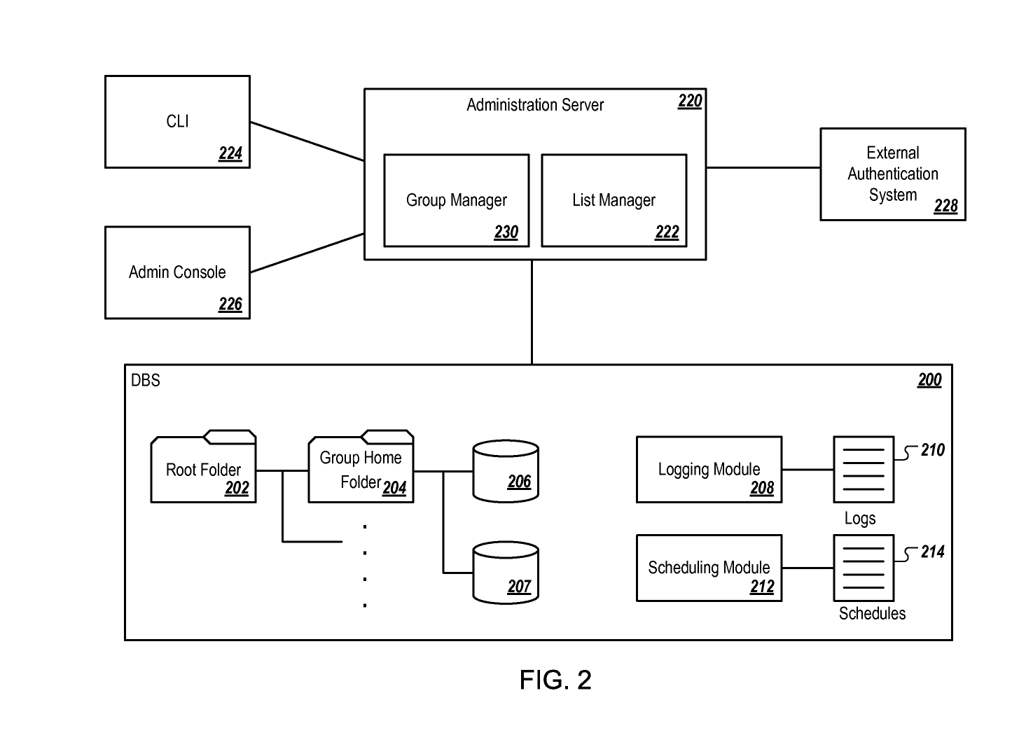

FIG. 2 is a block diagram illustrating an exemplary system for implementing administration groups. In various implementations, database server 200 can support multiple databases 206 and 207 that run concurrently. Database server 200 can be configured to perform various actions not only on multiple databases 206 and 207, but also on group home folder 204 that stores the databases 206 and 207.

For convenience, database backup operations are used to illustrate the actions. Database server 200 can support various backup schemes. Backing up database 206 can include writing data and schema of database 206 to one or more files on a separate sever. Database server can be configured to enable backing up of an entire group home folder 204 that includes multiple databases 206 and 207. To backup multiple databases 206 and 207, database server 200 can run a backup schedule (e.g., schedule 214) using scheduling module 212. The backup schedule can include various settings. Some exemplary backup settings can include backing up all databases, backing up databases in a particular folder, and backing up individual databases.

An exemplary “backing up all databases setting” can allow all the databases in a group's home folder to be backed up. An exemplary “database in folder” setting, when set, can cause database server 200 to backup all databases (e.g., databases 206 and 207) in a particular folder (e.g., 204). The “database in folder” setting can differ from the “backing up all databases” setting in that under the “database in folder” setting, databases of a particular subfolder of a home folder, rather than the entire home folder, can be backed up. This can apply when, for example, the home folder is a root folder that can contain subfolders. The backup operations can be performed by a group administrator.

Databases 206 and 207 can be implemented using one or more database files. A database (e.g., database 206) can include a collection of information. The information can contain one or more tables pertaining to a subject, such as customers or invoices. The one or more database files of database 206 can be stored in folders (e.g., folder 204). Folders in a database server can be organized in a hierarchical structure, containing one or more root folders (e.g., root folder 202) and one or more subfolders (e.g., folder 204). Backup operations can be performed on either root folder 202, subfolder 204 or an individual database file. The folder or database to be backed up is called a source folder or a source database for the back up.

If root folder 202 is chosen as a source folder for a backup operation, database server 200 can recursively back up all databases 206 and 207 in all subfolders (e.g., subfolders 204) of root folder 202.

Root folder 202 can be a default system folder designated in database server 200. Root folder 202 can be a place on a file system in which the database files are stored and served. Root folder 202 does not have to be a root directory in a file system. For example, root folder 202 can be a directory “[hard drive name]/system/database/dbroot.” In some implementations, database server 202 can designate a default root folder and an optional second root folder (e.g., an “additional” root folder), the path of which can be defined by a user.

In some implementations, to avoid arbitrarily complex file structures for databases, database server 200 can limit how many levels of subfolders can exist in root folder 202. For example, database server 200 can specify that only one level of subfolders under root folder 202 can be used for hosting databases. In such cases, database server 200 need not recognize a database in deeper level subfolders, although the deeper level folders can be used for other purposes.

In some implementations, the “databases in folder” option can be available to a group administrator if the group's home folder is a root folder. For example, instead of designating folder 204 as the home folder for a group, a server administrator can designate root folder 202 as the home folder of the group. If home folder 204 is a subfolder of root folder 202, the “databases in folder” option can be made hidden from the group administrator because the group administrator's privilege for backing up databases can be limited to home folder 204 (e.g., the group administrator cannot backup root folder 202).

In addition to backing up group home folder 204 using “databases in folder” option, an administrator can select which database in a folder to backup. The administrator can either select an individual database (e.g., database 206 or 207) to backup, or select all databases using an “all databases” option on a database selection panel. If the user makes an “all databases” selection, behaviors of database server 200 can differ based on a role of the user. If the user is a server administrator, the backup can be performed on all databases in all root folders 202 and their subfolders. If the user is a group administrator, the backup can be performed on all databases in the group's home folder, including subfolders if the home folder is root folder 202.

A backup operation is described above to illustrate operations performed on group home folders and root folders. In addition to backup operation, other operations (e.g., verify, run script, or send message) can be similarly performed.

The operations can be associated either with a database within the group (e.g., “Finance”) or the group's home folder 204 (e.g., folder “finance,” which is bound to the “Finance” group). The operations of databases within a group can be inferred from the location of the databases (e.g., in which group home folder the databases are stored). For example, if a server administrator creates schedule 214 (e.g., a schedule for backup operations) on databases in folder 204 that is bound to the “Finance” group, schedule 214 can be automatically added to a list of schedules that a “Finance” group administrator can see. In addition, if home folder 214 for the “Finance” group is changed to another folder (e.g., from “finance” into “sales”), the “Finance” group administrator can see all the databases, schedules and clients that are associated with the “sales” directory. Meanwhile, all the databases, schedules, and clients for the previous “finance” folder binding can be removed.

As a result, a group identity and a physical location can be loosely associated (e.g., can be reconfigured or rebound). The loose association between group identity and physical location can simplify tasks of maintaining the system, for example, during migration and upgrading. For example, when upgrading a database system to use the administration groups features, existing schedules associated with folders can be given to the groups when the folders are designated as the home folders of the groups. Also, when upgrading a particular database to a new version, existing data structures for the group do not need to be upgraded (e.g., a backup schedule can be applied to the new database, by virtue of the location of the new database).

Overhead of group management can be reduced from managing a hierarchy of databases into managing folders (e.g., by moving folders around or renaming folders). For example, if a new database is created and placed into a home folder of a group, the group administrator can automatically manage the new database. In addition, existing schedules and settings can automatically apply to the new database. If the database is moved from a first home folder to a second home folder (e.g., by a server administrator), management rights on the database can be automatically transferred from group administrators of the first group to group administrators of the second group.

The administration groups can be an optional organizational layer on top of an existing system. An enterprise that scales up and decided to use the administration groups features can do so easily without losing existing databases and schedules. The set up required can be minimal.

### Logging Groups Events

Database server 200 can log messages related to groups in event log file 210 (e.g., Events.log) using logging module 208. The messages can be viewed in a log viewer. Event log file 210 can also contain messages from server schedules (e.g., scheduled backup events), as well as messages from individual databases.

The following exemplary event log messages can be implemented to support operations performed on a database application system 100:
Administration group “Finance” created, using folder “ . . . Databases/FinanceDBs/;”
Administration group “Finance” deleted;
Administration group “Finance” modified, using folder “ . . . Additional/FinanceDBs/;” and
Administration group “Finance” renamed to “Accounting”, using folder “ . . . Additional/FinanceDBs/.”

Administration group messages can include the group's home folder location. The home folder location can provide useful information to both group administrators and server administrators, because the folder location can have an impact on schedules.

Event log messages can include a string identifying the administrator (server administrator or group administrator) who performed the logged action (e.g., which account or user deleted a group's schedule). Since some actions can be performed by either a server administrator or a group administrator, including an administrator using an externally authenticated account, a message can use a string ServerOrGroupAdmin to indicate the role of the administrator.

ServerOrGroupAdmin can have one of the following exemplary types of values:
Server Admin account name (e.g., “AcmeAdmin”);
Server Admin account name followed by external account name (e.g., AcmeAdmin:Sally”, where Sally is a member of the externally authenticated group assigned for Server Admin);
Group name (e.g., “Finance” or “Dev”); and
Group name followed by external account name (e.g., “Finance:Joe”, where Joe is a member of the externally authenticated group assigned to the Finance group).

The following exemplary event log messages use ServerOrGroupAdmin values:

Administrator connected: “ServerOrGroupAdmin” (10.0.0.1); and

Administrator disconnected: “ServerOrGroupAdmin” (fe80::1).

The exemplary messages above can be logged when an administration server or a command line interface starts and stops connection to the database server. Exemplary IP address (10.0.0.1) in the messages above can be an IP address of an administrative console client machine, which can be retrieved by an administration server.

The following are more exemplary event log messages on schedule, database upload, database operations, and client messages:
Schedule “DailyFoo” created/deleted/modified/started by “ServerOrGroupAdmin;”
Database upload started by “ServerOrGroupAdmin;”
Database “Records.fp7” opened/closed/paused/resumed/verified/removed by “ServerOrGroupAdmin;” and
Client “somebody” disconnected by “ServerOrGroupAdmin”; Message sent: “something.”

### Managing Administration Groups

Some application logic of administration groups can be implemented in administration server 220, administrative console 226, and command-line interface 224 (CLI). Administration server can implement functions in at least four exemplary function areas. The four areas include: group management, which can include functions to define groups, associated databases, and credentials; external authentication, which can include functions for using existing and externally managed user authentication systems 228; privilege functions, which can include functions for controlling access to operations and user interfaces for group administrators; and list retrieval, which can include functions for identifying and filtering list items (schedules 214, databases, clients, etc.) by group. Each of the function areas will be described in further details below.

Group manager 230 can perform group management functions. Group manager 230 can include one or more group data structures and an application programming interface (API) that allows for management of groups, and a list of groups. Group manager 230 can enable a server administrator to add, delete or edit group members, persistent storage for the groups, and managing authentication using passwords and external systems.

A group data structure can contain all attributes or properties that can define a group. A collection of group data structures can represent all the groups in the system. These group data structures can be persisted to disk so that the collection can be restored if the system is offline and then brought online again. Some attributes of the group data structure can include:
ID, which can include an internal identifier that is unique and immutable in the system (e.g., a primary key for the group);
Name, which can include a label that can be displayed in the UI to identify a group to the user (a validation in the UI can enforce that the group name is unique);
Password;
External Group, which can be an optional field that can bind the group to an external group if external authentication is used;
Privileges, which can include a collection of rights which allow the group access to operations and views; and
Home folder, which can include a home database folder for the group. All databases in this folder can belong to the group and databases uploaded to the group can be placed in this folder.

Creating a group can be done in a “define group” panel in group configuration panel 530. Group configuration panel 530 will be described in further detail below with respect to FIG. 5C.

As indicated above, group management can include persistent storage of the group. Persistent storage can include storing administrator group attributes to a configuration file.

Home folder 204 can be the physical directory on disk where the group databases 206 and 207 will reside. The “home folder” attribute in the definition of the group can have significant implications in the system. For example, the “home folder” attribute can affect the number of groups that can be defined and the locations and operations on the associated databases. Changing the home folder designation after the group has been defined can affect behavior of scheduling module 212 after schedules 214 have been created (e.g., on backing up folders in the system).

The following paragraphs will discuss how the selection of the home folder can constrain the number of groups defined in the system. To begin with, the system can use the following exemplary rules concerning group home folder definitions to constrain the definition of the group:
A sub-folder of an existing group can be excluded from being designated as a home folder of another group;
A parent folder of an existing group can be excluded from being designated as a home folder of another group;
A home folder of an existing group can be excluded from being designated as a home folder of another group; and
A home folder can be one of the root folders if the first three rules are not violated.

Exemplary scenarios involving one administration group, two administration groups, and an arbitrary number of administration groups will be described below.

In some implementations where the above rules are applied, one administration group can exist on the system. For example, a server administrator can partition database administration from server administration. The configuration does not necessarily define an “additional database folder.” To create this partition, the server administrator can create a group and set the home folder of the group to the default root folder (e.g., . . . /DBServer/Data/Databases/).

In this situation, the system can prohibit the definition of any additional groups. There can be exactly one group and no additional groups can be created until the group home folder is unassociated with the default root or an additional database folder is set in the configuration.

In some implementations, two administration groups can exist on the system. A similar situation arises if an additional database folder is defined in the database server configuration. The server administrator can create a new group, and use the additional root folder as the home folder for the new group.

In this situation, no additional groups can be defined and there will be exactly two groups in the system. No additional groups may be defined until one or both of the root folders have been unassociated with one or both of the groups.

In some implementations, an arbitrary number of administration groups can exist on the system. If one of the root folders (either the default root folder or the additional root folder) does not have an associated group, then the system can support an arbitrary number of groups. The group home folder can be a subfolder of that unassociated root. All additional group folders can be sibling folders of the group home folder. The number of groups defined in this situation can be limited by the underlying file system. Once a subfolder becomes a group home folder, the parent root folder can be prohibited from becoming a home folder for a group.

Administration server 220 can include external authentication functions, performed in conjunction with external authentication system 228.

An internal authentication process can use name and password of a group to authenticate a user as the group administrator. Internal authentication can be sufficient for small businesses and departments. However, for larger enterprises that have a significant number of departments, developers, or administrators, a mechanism that is more scalable can be implemented, where a shared login credential can be provided to all of the users who already have usernames and passwords defined elsewhere who wish to gain access to the system for database administration purposes.

External authentication can be a powerful yet optional feature that can be used to simplify user access accounts for group administration. Larger enterprises can use an existing user management system like Lightweight Directory Access Protocol (LDAP) or Active Directory. Providing a mechanism to integrate with these systems can simplify account management in larger enterprises

If an external group name is associated with the internal database administration group, external authentication can be enabled for that group. A user who is a member of that external group can use the user's external login id and password to manage the group.

In some example implementations of external account management, external authentication system 228 (e.g., an Open Directory system) can be used to define a new external group called “finance.” All members of the “finance” group can have administration privileges on the internal Finance group. A mapping between the external “finance” group and the internal Finance database administration group can be established in the administrative console 226. An Open Directory login ID that is a member of the external “finance” group can be used to gain access to the internal Finance administrative group.

For example, if Joe has external user ID “joe” and is a member of the external “finance” group, then Joe can use his external user ID “joe” and external password to login to administrative console 226. Granting or removing access to the Finance administration group can be implemented using external tools for user management. For example, if Joe left the Company, his user id “joe” can be deleted by a Company human resource representative using a workgroup manager in external authentication system 228. No action needs to take place in administrative console 226 or administration server 220.

A login user can be a member of multiple authentication groups (a multi-group user) in external authentication system 228. For example, “finance” and “sales” can be two external groups, and Joe can be a member of both groups. In such cases, the multi-group user “Joe” is not required to exit the application in order to change groups. Instead, authentication system 228 can provide a mechanism for the multi-group user to switch between administration groups.

Administration server 220 can include privilege control functions, which can include functions for controlling access to operations and user interfaces for group administrators. Access privileges can be used as a mechanism for limiting the abilities of group administrators to access or modify various functions, databases, or schedules. Access privileges can be assigned to each group by the server administrator. Access privileges of all group administrators for the group can be determined by the privileges assigned to the group. When a user logs into a particular administration group with the group name and password or his user credentials that are mapped to an external group, the user can perform all the tasks that have been assigned to that administration group. For example, privileges can specify that administrators who log into the “Finance” administration group can not create and run schedules while administrators of the “Sales” administration group can.

A server administrator can be granted all the privileges in the system upon successful login. The server administrator can perform all operations on any database in any administration group. Furthermore, the server administrator can be allowed to configure the administration server 220 and database server 200, and create and manage administrator groups. In some implementations, the server administrator can retain a level of access and functionality similar to a “super user” in some operating systems.

Group administrators can only manage the databases within their groups. A group administrator need not have server administration privileges, and can be precluded from server administration functions, such as:

Start/stop database server 200;

Start/stop web publishing;

Access or see a configuration node or child nodes;

View or edit server deployment; and

Register the database application product or update a license.

Access privileges of group administrators can depend on the privileges that the server administrator has assigned to the particular administration group being accessed. Some predefined privilege sets can be created which combine functionality to simplify the combinatorial matrix of privileges. The following are some exemplary predefined privilege sets.

A default set of privileges can provide a group administrator with all of the following privileges:

Viewing database, clients, and schedules;

Sending message to user(s);

Disconnect client(s); and

Access test pages, start pages, and context sensitive help.

Database management privileges can provide a group administrator with all of the following privileges for managing database within the group administrator's group:

Open/close/remove/upload/pause/resume/verify databases.

Schedule management privileges can provide a group administrator with privileges for managing and running schedules (e.g., schedules 214) for the databases within the group administrator's group. This privilege set can have multiple parts. A basic privilege can allow general access to core scheduling functionality (e.g., run, create, edit, delete). If the group has the basic scheduling privilege, the group can also have the “Send Message” privilege. Additional privileges can granted to give the group additional scheduling types. In some implementations, a group must have basic privileges before additional privileges can be assigned to the group. The following are exemplary basic and additional privileges:

Run, edit, delete and create schedules: basic privilege;

Send message: basic privilege;

Backup databases: additional privilege;

Verify databases: additional privilege; and

Run Script: additional privilege.

Runtime diagnostics privileges can provide a group administrator with of the following privileges for viewing runtime diagnostic data on server operations:

Log viewer; and

Statistics viewer.

A group administrator can get a limited view of clients, schedules, and databases. For example, administration server 220 can restrict the view of the group administrator to displaying only those items that relate to the databases within the group. Administration server 220 can include list manager 222, which can be responsible for managing lists of various items. Some exemplary items in the lists can include clients, schedules, and databases. List manager 222 can include functions for filtering the lists of items by group. Some exemplary filtering functions in list manager 222 are listed below:

Getting a set of clients for a group;

Getting a set of schedules for a group; and

Getting a set of databases for a group.

List manager 222 can include an API for accessing the filtering functions. In some implementations, a façade (e.g., a unified interface to a set of interfaces in a subsystem) or a decorator (e.g., additional responsibilities dynamically attached to an object) can be added to generic functions the filtering. A group identifier can be used to filter lists of clients, schedules, or databases to achieve.

Administration server 220 can include a data structure and API for identifying current administrative console sessions in administration server 220. Identifying current administrative console sessions can be used for identifying users and their groups to ensure that conflict resolution can be addressed.

Administrative console 226 client can have a token (e.g., a data structure containing identification information) for identifying an administrative session. The token can be passed to administration server 220 when a privileged operation is executed. Administration server 220 will validate the token to ensure that a group has sufficient privileges to enable the group administrator to perform the operation. If the token is invalid, an “OperationNotSupported” exception can be generated. Administration server 220 can catch this exception and notify the group administrator that the group does not have sufficient privileges to perform the operation. The token can include attributes that identify the client. Some exemplary attributes include:

User name, which can include the login id of the current user;

Group ID;

IP Address; and

Host name.

Exemplary interactions between a group administrator or a server administrator and administration server 220 are described with reference to administrative console 226.

### Exemplary Processes for Creating and Using Administration Groups

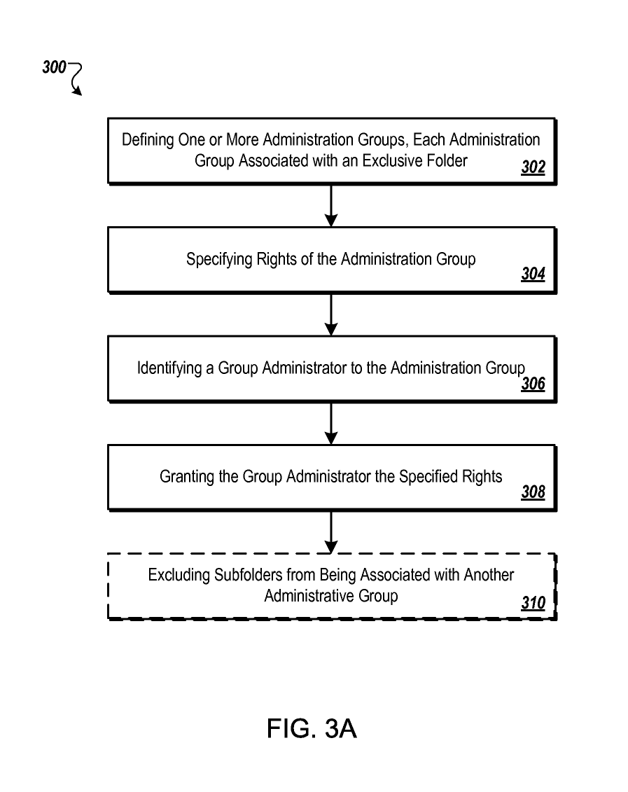

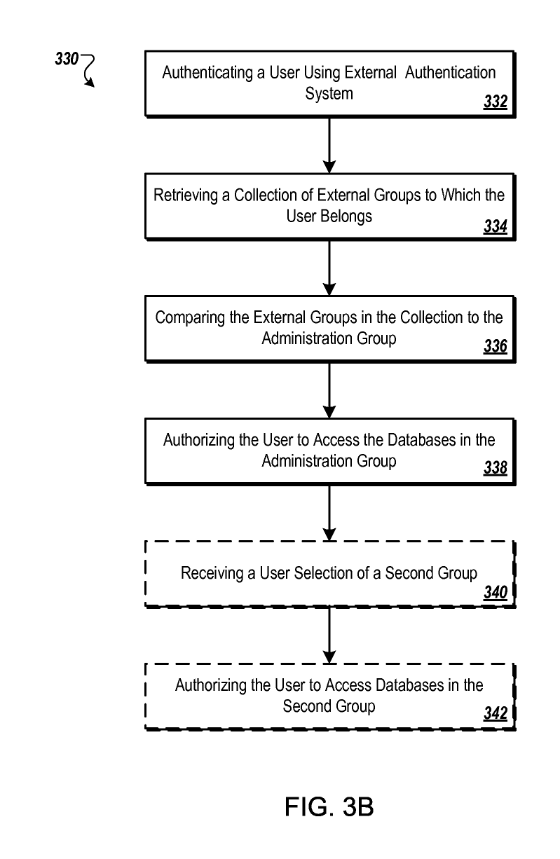

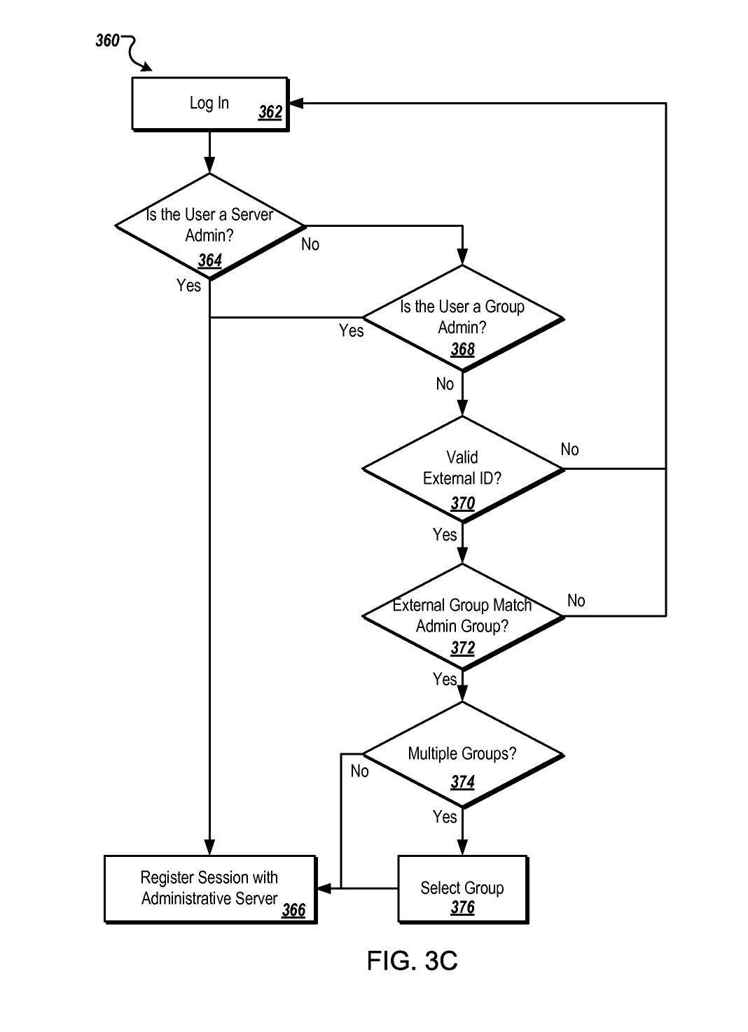

FIGS. 3A-3C are flowcharts illustrating exemplary processes for creating and using administration groups to determine user access privileges. FIG. 3A is a flowchart illustrating an exemplary process 300 for creating administration groups. For convenience, the exemplary implementations will be described with respect to administration server 220 that performs the techniques, and a user using administration server 220.

Administration server 220 can define (302) one or more administration groups on a server. Administration server 220 can use the administration groups to delegate administrative tasks of a server administrator to a group administrator. Each administration group can be associated with an exclusive home folder that maps to a folder on a file system. The home folder can contain one or more databases. The databases can include collections of database tables, which can be stored on the file system as one or more database files.

Administration server 220 can specify (304) rights of each administration group. The rights can include permission to manage the databases in the home folder and permission to create new databases in the home folder. The rights can be applicable to databases in the administration group (e.g., in the home folder). For example, an administrator of a Finance group does not have rights to a Sales group. Therefore, the rights associated with administration groups can be more restricted than general server administration rights, which can be applied to all databases in all folders.

Specifying (304) the rights of each administration group can include identifying a relative position of the home folder with a root folder. The home folder can be a root folder (e.g., a default root folder or an additional root folder). The home folder can alternatively be a subfolder of one of the root folders. Administration server 220 can specify rights to perform various operations on the databases based on the relative position. For example, if the home folder of an administration group is a root folder, rights for backing up all “databases in folder” can be an available option. In contrast, if the home folder of an administration group is a subfolder of a root folder, rights for backing up all “databases in folder” can be unavailable since there are no additional subfolders. Under this scenario, there can be two options: backing up all databases in the home folder, or backing up individual databases.

Administration server 220 can identify (306) a group administrator to the administration group. A group administrator can be any user who can access the group. Because various rights can be associated for groups, a user of a group can have the rights to access all databases in the group home folder, as well as creating new databases in the home folder. The group administrator's access rights can be distinct from access rights of a regular database user, because a regular database user generally can access particular databases, rather than a group of databases. Furthermore, a regular database user cannot delete or create databases.

In some implementations, identifying (306) a group administrator can include designating a group name and a group password for the administration group. Administration server 220 can authenticate the group administrator using the group name and password. In some implementations, identifying (306) a group administrator can include utilizing an external authentication system (e.g., an authentication system that is external to the server). External groups and individual external users can be defined on the external authentication system. The external groups and users can each have a name (e.g., a group name or a user name) and a password (e.g., a group password or a user password).

Administration server 220 can map external groups to administration groups. The mapping can be maintained persistently (e.g., stored on a storage device). Using similar names for external groups and administration groups (e.g., “finance” external group to Finance administration group) can make the mapping more user-friendly. However, any external group can map to any administration groups. An external user can be mapped to multiple administration groups if the user belongs to multiple external groups.

Administration server 220 can grant (308) the group administrator the specified rights. Once authenticated, the group administrator can perform various tasks on the databases within the administration group. The tasks can include scheduling operations traditionally performed by a server administrator (e.g., database backup, verify, open or close client connections, etc.). However, the tasks can exclude some operations that are reserved for the server administrator (e.g., server shutdown, system registration, license renewal, performance tuning, etc.)

The home folders of various administration groups can be organized according to the rules specified above. In some implementations, subfolders of the home folder of a first administration group can be excluded (310) from being designated as home folder of a second administration group.

FIG. 3B is a flow chart illustrating an example login process using external authentication. A user can be authenticated (332) using the user's external user ID and password. The authentication can occur, for example, when the user accesses administrative console 226.

Administration server 220 can retrieve (334) a collection of external groups in which the user is a member (e.g., the external groups to which user ID belongs) from external authentication system 228. Membership of external user IDs and external groups can be managed by external authentication system 228 and transparent to administration server 220.

Administration server 220 can compare (336) the collection of external groups with internal administration groups that have been mapped to external groups. If there is match, administration server 220 can authorize (338) the user to access the corresponding internal administration group from administrative console 226.

Optionally, administration server 220 can prompt the user to select an administration group that the user wishes to manage, when the user belongs to more than one external group in external authentication system 228. Administration server 220 can present an interface for selecting a current administration group from multiple administration groups, when the multiple administration groups match the external groups in the collection, and each of the external group corresponds to an administration group. Administration server 220 can receive (340) a user selection from the interface.

Administration server 220 can authorize (342) the user to access databases in the selected administration group. Administration server 220 can include a mechanism that allows the user to change administration groups after a single login, without restarting the administration server 220 or repeating a login sequence.

FIG. 3C is a flowchart illustrating exemplary login sequence 360 for a server administrator or a group administrator. Administrative console 226 can receive (362) user login credentials through a login dialog. User login credentials can include a user ID and a password. Administrative console 226 can determine (364) whether the user ID is that of a server administrator. The determination process can be performed by a backend engine (e.g., administration server 220).

If the user ID is determined to belong to a server administrator, administrative console 226 can register (366) a session with administration server 220, in which the user can perform server administration tasks. The session can be a period of time that interactive information exchange between a user and administration server 220 can occur, during which the user can perform various actions according to the privileges of the user as defined by administration server 220. Registering (366) the session can include starting the session using parameters that contain the user ID, group name, host name, host IP address, etc.

If the user ID is determined not to belong to a server administrator, administrative console 226 can determine (368) whether the credentials represent to group administrator. The determination can be made by comparing the user ID with a list group IDs internal to the system (e.g., Finance). If the credentials are determined to correspond to a group administrator, administrative console 226 can register (366) a session with administration server 220.

If the credentials are determined not to correspond to a group administrator, administrative console 226 can determine (370) whether the credentials represent a valid external authentication group using external authentication system 228. External authentication system 228 can be an Open Directory or Active Directory system.

If the credentials do not represent a valid external authentication group, administrative console 226 can return to a receiving mode, to receive (362) login credentials again. If the credentials represent a valid external authentication group, administrative console 226 can further determine (372) whether the external authentication group matches one or more internal administration groups.

If the external authentication group does not match any internal administration group, administrative console 226 can return to a receiving mode, to receive (362) login credentials again. Otherwise, administrative console 226 can determine (374) whether the external authentication group matches multiple internal administration groups. If yes, administrative console 226 can present (376) a user interface for the user to select a group among the multiple groups to manage. If no, or after a user selects a group, administrative console 226 can register (366) a session with administration server 220, in which the user can perform group administration tasks.

### Group Administration User Interface

FIGS. 4A-4F illustrate exemplary user interfaces for a group administrator. Group administrators can access one or more administrative consoles 226. Administrative console 226 can include user interfaces with which a user or an administrator can interact with various groups features. In some implementations, a login dialog box can be the first dialog box that appears after the user launches administration server 220. The user can enter a login ID and password into appropriate fields. The login ID and password can be authenticated. Upon valid authentication, administration server 220 can open the main user interface of administration server 220, initialize data structures and present a view that is appropriate to the user's privileges and group.

FIG. 4A illustrates an exemplary main user interface 402 for a group administrator. Administration server 220 can display main user interface 402 to an administrator of a group that has database and statistics privileges. Main user interface 402 can include a server information component 404 (e.g., a panel) and a overview panel 420. Server information component 404 can display information (e.g., statistics) related to a server. This component can be excluded from main user interface 402 for groups without statistics privileges. Overview panel 420 will be described in more details below with respect to FIG. 4C.

FIG. 4B illustrates an exemplary group selection dialog box 410 for a user to select an administration group to login. In some instances, administration server 220 can require additional information during login. If external authentication is used and the user being authenticated is a member of multiple administration groups, dialog box 410 can appear after the login panel, so that the group to be managed can be selected.

Combo box 412 can show a set of internal group names the user is authorized to manage. “OK” button 414 can be a default button and can accept the selected group in combo box 412 when invoked. An API of administration server 220 can include a method that returns a set of matching external groups for a user ID. This set is compared with the external group field for all administration groups defined in administrative console 226. If there is exactly one match, group selection dialog box 410 need not be shown. If there is more than one match, group selection dialog box 410 can be presented with the matched internal group names in combo box 412 in alphabetical order.

FIG. 4C illustrates an exemplary overview panel 420 for a group administrator. After a successful login, administration server 220 can present overview panel 420 as a default view to the user. A name of the managed group 422 can be shown on a top section of overview panel 420. Status graph 424 can show health of various components in the center of overview panel 420

FIG. 4D illustrates an exemplary client view panel 430 for a group administrator. For a group administrator, clients that are connected to databases managed by the group can be shown in “connected clients” table 432. For a server administrator, a group name that can identify the group for the connected client can be displayed. The group name (e.g., Finance) can be displayed in “details for client” table 434, in a column under the heading “Group Name.”

FIG. 4E illustrates an exemplary database view panel 440 for a group administrator. Database view panel 440 can be presented to an administrator of a group that does not have open, close, verify, upload, and remove databases privileges. The group administrator can view databases in the group using database view panel 440. Root 442 of database tree can reflect the home folder, which can be defined in a group configuration panel 530. Group configuration panel 530 will be described in further detail below with respect to FIG. 5C.

FIG. 4F illustrates an exemplary user interface 450 for a user to change groups. There exists a special case for a group administrator if external authentication has been defined for the group and the login user belongs to multiple authentication groups. For example, Joe can be a user whose login ID “joe” has been defined in external authentication system 228. Joe belongs to two external groups “finance” and “sales,” mapping to administration groups Finance and Sales, respectively. When Joe logs in, group selection dialog box 410 can be presented for him to select the admin group he would like to manage. Joe chooses “Finance.”

If Joe wishes to manage the “Sales” group of databases, Joe can use user interface 450, which can include a “Groups” item that can allow him to pick the group that he wants to administer. Submenu 452 under “Groups” item can appear under a server menu and can contain a list of items that match the names of the group that the login user belongs. Continuing the example, Joe can be presented with the items Finance and Sales in the submenu 452. Items Finance and Sales can be mutually exclusive. A check box can appear next to the active group being managed.

When the non-active group is selected, main user interface 402 can close, a new main user interface 402 can appear. Overview panel 420 can display view of the selected new group. If the logged in group administrator belongs to only one group or the server administrator is the logged in user, submenu 452 need not be visible.

### Server Administration Interface

FIGS. 5A-5D illustrate exemplary user interfaces for a database server administrator. FIG. 5A illustrates an exemplary database panel 500 for the database server administrator. On database panel 500, the database server administrator can see hierarchy 502, including root folders and all group home folders.

In contrast, a group administrator can see the set of databases that belong to the group. No other folders in the system can be visible to the group administrator. However, if the group home folder is one of the root database folders (“default” root or “additional” root), any subfolders below the root can also be visible. In such cases, the group administrator can see a hierarchy similar to hierarchy 502, except that the group administrator does not see the second root folder (e.g., the “Additional” folder, if defined).

The name of the folder can be shown together with a corresponding group name. The group name can be represented in brackets alongside the name of the folder. A name of the folder can be the directory name in a file system (e.g., “finance_dbs”). The corresponding group can have a name “Finance.” The relationship between the folder name and the group name can be displayed in all user interfaces of the database application where the folder hierarchy is represented. For example, an upload assistant used by an administrator for uploading database files into folders can show the group name in a panel that prompts for the target directory.

FIG. 5B illustrates an exemplary schedules panel 510 for a database server administrator. For a group administrator, the only schedules visible in “Schedules” table 512 can be ones that are associated with databases managed by the current group. If the group administrator does not have schedules permission, the view can be configured to reflect a read only presentation of the schedules.

For a server administrator, “Schedules” table 512 can display all schedules in all groups. “Group” column 514 can be used for identifying to which group the schedule belongs. “Group Name” field 518 be displayed in “Details for Schedule” table 516 as a row when the schedule is selected.

FIG. 5C illustrates an exemplary group configuration panel 530 for a server administrator. A server administrator can be a role in the system that can create and manage groups. “Save” button 532 can be used to commit changes to the fields. “Revert” button 534 can be used to restore modified fields to the previous saved state.

A server administrator can perform the following actions using group configuration panel 530:

Create and manage administration groups (e.g., add, edit and delete groups);

Set and change an administration group password;

Bind an external group to a current internal administration group;

Selecting a home folder for the administration group; and

Set privileges for the administration group.

A complete list of the managed groups can be presented in group list 536 on the left portion of exemplary group configuration panel 530. Items in group list 536 can be the names of the groups, and can be sorted alphabetically in ascending or descending order. Group list 536 can be configured to support selection states such as single selection or no-selection. In some implementations, multi-selection can be prohibited. The selection state of group list 536 can have impact on an enabled state of several controls in group configuration panel 530.

Selecting an item in group list 536 can cause properties of the selected group to be displayed in a right portion of configuration panel 530. If a group is not selected or there are no groups then the fields will be blank. The fields for the selected group can be edited. Changes can be committed to the group by pressing “Save” button 532. If no items are selected, the editable controls can be empty, and the controls can be disabled.

Two buttons 534 and 536 below group list 536 can be used to manage contents of group list 536. Pressing “Add” button 538 can add a new group to the system. In general, “Add” button 538 can be always enabled. However, if the system reaches a limit on the number of groups (e.g., one or two groups), “Add” button 538 can be disabled. Under these circumstances, one way to re-enable “Add” button 538 can be changing the home folders of the existing groups (e.g., by disassociating the home folder from a root folder). “Remove” button 540 can be enabled when a group is selected. Pressing “Remove” button 540 can remove a selected item (e.g., delete a group) after a small confirmation dialog appears.

Pressing “Add” button 538 can add a new group in the following exemplary process. Pressing “Add” button 538 can add a new group to group list 536. The new group can have a default name “Group Name 1.” The trailing digit can increment to ensure that all entries are unique.

An input focus can be placed in group name text field 542. Initially, the default “Group Name 1” text can be selected. The server administrator can edit the name of the group to reflect a desired group name (e.g., “Finance”). Initially, a new list entry can still reflect the default group name until the server administrator's edit has been entered.

When the input focus moves out of group name field 542, the text (e.g., “Finance”) can be validated to ensure that the name is unique. If not, input focus can be transferred back to group name field 542. Text in group name field 542 can be highlighted (e.g., in yellow) to indicate that a problem has occurred.

The server administrator can edit other fields in group configuration panel 530. For example, the server administrator can use password field 544 and password confirmation field 546 to set and change password for the group

The server administrator can press “Save” button 532 to commit the new group and its properties. The name in group list 536 can reflect the new group name.

Alternatively, the server administrator can press “Revert” button 534 to roll back the added group. The new group can removed from group list 536. No selection can be shown on group list 536. Editable control fields can be blank and disabled.

Group configuration panel 530 can allow the server administrator to specify an “external authentication group.” External authentication is an optional feature that can allow for the use of existing user authentication systems to integrate with the database application system. External authentication can allow the following controls:
“Allow Login” checkbox 548 can enable or disable the other controls that govern external authentication. If unchecked, external authentication will not be used;
“External Group” text field 550 can be an unformatted field used to enter an external group associated with the current group. The burden can be on the server administrator to know which external groups are correct values for this field;
“Validate External Group” button 552 can be used to invoke a group validation operation, which checks the existence of the external group entered in “External Group” text field 550; and
“Status” label 554 can report on the results of the group validation operation. An initial state of “Status” label 554 can be empty. If the external group is valid, “Status” label 554 can read “Validated.” An empty or invalid external group name in “External Group” text field 550 can be reported as “Invalid.”

Enabling external authentication does not necessarily disable the group name and password authentication. If the server administrator does not wish to allow group name authentication, the server administrator can keep the password secret (e.g., does not distribute the password).

If “External Group” text field 550 is blank or does not reflect an existing externally managed group, external authentication can be disabled for this group. External authentication can fail silently for a user with a generic “Invalid User Name/Password” message box. The server administrator can ensure that the external authentication mechanism is working correctly by using “Validate External Group” button 552. The server administrator can manage user accounts in the external system. However, it is not necessary that the server administrator is responsible for managing user accounts in the external system.

“Home Folder” label 556 can be a read-only text string that indicates the current home folder of the group. “Home Folder” label 556 can be set or changed using “Select Folder” button 558.

“Select Folder” button 558 can be used to allow for management of database folders. Pressing “Select Folder” button 558 can invoke a folder dialog box that can allow for creation and deletion of subfolders (under one of the root folders) as well as selecting the home folder for a group. If the user selects a folder that has already been designated as a home folder to a group, an “OK” button on the folder dialog box can be disabled. The enabled status of the “OK” button on the folder dialog box can reflect group home folder selection policies as described above in the “Managing Administration Groups” section of this specification. Furthermore, the “OK” button can be enabled if a selected tree node represents the home folder of the current group. This can allow a group that is currently bound to one of the root folders to select a subfolder of that root. The folder dialog box can also include “Add” and “Remove” buttons for adding or removing folders. The enabled state of the “Add” and “Remove” buttons can reflect current folder creation rules in an upload assistant.

When the server administrator dismisses the folder dialog box (e.g., by clicking the “OK” button) and changes have been made, “Home Folder” label 556 can be re-set with the full path of the group's new home folder.

“Privileges” section 560 of group administration panel 530 can contain a static text area for the association of privileges. The static text area can contain a read-only enumeration of the current set of privileges. By default the static text area can contain default privilege items “View Databases,” “Send Messages,” and “Disconnect Clients.” Other privilege items can be configurable and can be listed if the current group contains those privileges.

Pressing “Edit Privileges” button 562 can invoke a secondary modal dialog (e.g., edit privileges dialog 580), which can allow the specification of privileges. Edit privileges dialog 580 will be described below with respect to FIG. 5D.

FIG. 5D illustrates an exemplary edit privileges dialog 580 for a database server administrator. The following sets of privileges can be selected in edit privileges dialog 580:

Open, Close, Verify, Upload or Remove Databases;

View Statistics and Logs;

Run, Create, Edit and Delete Schedules;

Back Up Databases;

Verify Databases; and

Run Script.

Controls that govern schedule privileges can have a dependency structure. When a basic set of schedule privileges (Run, Create, Edit and Delete Schedules) is selected, three additional privileges can be enabled for selection. The basic schedule privilege can include enabling a “Send Message” schedule type by default.

When edit privileges dialog 580 is accepted, the read only text area of “Privileges” section 560 of group administration panel 530 can be updated. In some implementations, four lines of static text can be displayed. The static text can be identical to the strings in edit privileges dialog 580, with the exception of the “Schedules” string.

The “Schedules” string of “Privileges” section 560 can include schedules privilege (if granted). The string can contain the base string “Schedules: Send Message.” Any additional schedule privileges can be concatenated to the base string. An exemplary set of schedule privileges can be “Schedules: Send Message, Back Up Databases, Verify Databases, and Run Script.”

### Conflict Resolution

Partition between system and group administrators can create a likelihood that multi-user collisions can occur. For example, a server administrator can do anything a group administrator can do, and thus can conflict with the group administrator's activity. Two or more group administrators belonging to a same group can cause conflicts.

To resolve conflict in scheduling, a locking mechanism can be implemented. A server administrator or group administrator can perform scheduling tasks using a scheduling interface (e.g., an “assistant” or “wizard” including one or more series of dialog boxes). Locking can be implemented for each schedule. For example, if Joe is editing a “Foo” schedule using a scheduling assistant, Bob cannot edit “Foo” with the scheduling interface. However, Bob can edit another schedule “Bar” with the scheduling interface.

A server administrator or group administrator can perform database upload tasks using an upload interface. Locking can be implemented for each group. For example, if Joe and Bob are managing a “Finance” group simultaneously, only one of Joe and Bob can launch the upload interface at a time. If Bill is managing “Sales” group simultaneously with Joe and Bob, Bill can launch the upload interface for group “Sales.”

If both the server administrator and group administrator are logged into the system simultaneously, actions of the server administrator can cause a conflict with operations performed by the group administrator. Some examples of potential conflicting areas include: changing privileges, changing a home folder, changing an external authentication group, and deleting the group. The server administrator can perform any of these operations while the group administrator is currently logged in. Such operations can cause a user interface of a group administrator to be inconsistent with the current set of parameters and privileges.

Privileged operations can contain session information (which can include the group ID) as a parameter. If the group administrator attempts to perform a privileged operation for which the group no longer has credentials, administration server 220 can throw an “OperationNotSupported” exception. Administrative console 220 can handle that exception by presenting a message box with the following exemplary message:
The group does not have the privileges to perform the operation. The authentication credentials may be out of date. Please restart the administrative console to re-initialize the application to reflect the new privileges.

A mechanism can be implemented to notify the server administrator when modifications are made to properties by group administrators. This mechanism can be used so that the server administrators can be notified such that the server administrators can make an informed decision to continue with a modification. If a group administrator is currently logged in and the server administrator attempts to commit changes to the group, a “Yes, No” message box can appear which will warn the server administrator of the impact. An exemplary warning message can be: “A Finance group administrator is currently logged in and may be impacted by the changes. Proceed?”

If the server administrator continues the operation by pressing a “Yes” button, the changes can be committed and the logged-in group administrator admin can be subjected to the new group properties committed by the server administrator. If the server administrator selects “No,” the changes will not be committed. Group configuration panel 530 can still reflect the changes in a “dirty” state. The server administrator can choose to revert (e.g., cancel) the changes or contact the group administrator to let the group administrator know that the server administrator will be making changes.

### Exemplary System Architecture

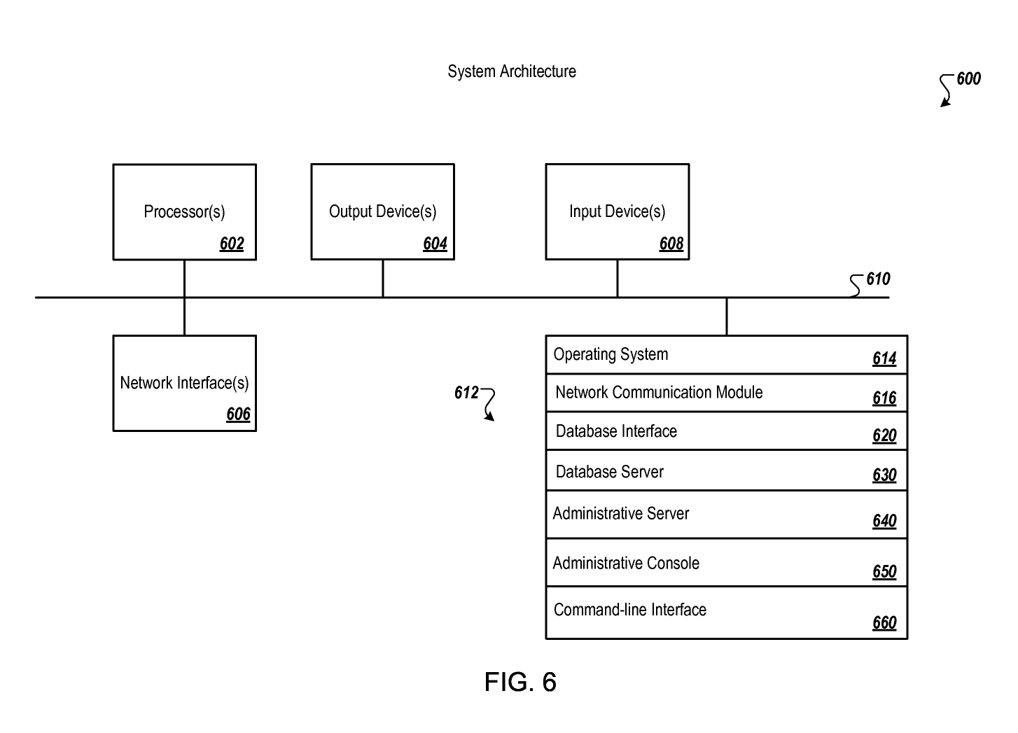

FIG. 6 is a block diagram of an exemplary system architecture 600 for implementing the features and operations described in reference to FIGS. 1-5. Other architectures are possible, including architectures with more or fewer components. In some implementations, architecture 600 includes one or more processors 602 (e.g., dual-core Intel® Xeon® Processors), one or more output devices 604 (e.g., LCD), one or more network interfaces 606, one or more input devices 608 (e.g., mouse, keyboard, touch-sensitive display) and one or more computer-readable mediums 612 (e.g., RAM, ROM, SDRAM, hard disk, optical disk, flash memory, etc.). These components can exchange communications and data over one or more communication channels 610 (e.g., buses), which can utilize various hardware and software for facilitating the transfer of data and control signals between components.

The term “computer-readable medium” refers to any medium that participates in providing instructions to processor 602 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 612 can further include operating system 614 (e.g., Mac OS® server, Windows® NT server), network communication module 616, database interface 620, database server 630, administration server 640, administrative console 650, and command-line interface 660, as described in reference to FIGS. 1-5. Operating system 614 can be multi-user, multiprocessing, multitasking, multithreading, real time, etc. Operating system 614 performs basic tasks, including but not limited to: recognizing input from and providing output to devices 606, 608; keeping track and managing files and directories on computer-readable mediums 612 (e.g., memory or a storage device); controlling peripheral devices; and managing traffic on the one or more communication channels 610. Network communications module 616 includes various components for establishing and maintaining network connections (e.g., software for implementing communication protocols, such as TCP/IP, HTTP, etc.). Database server 630 can host one or more databases on a file system. The databases can be organized under a hierarchical folder structure, the folders mapping to directories in the file system. Administration server 640 can perform various groups management functions, including mapping groups to home folders. Administrative console 650 can provide graphical user interfaces for managing database server 630 and administration server 640. Command-line interface 660 can provide command-line user interfaces for managing database server 630 and administration server 640.

Architecture 600 can be included in any device capable of hosting a database application program. Architecture 600 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations of the invention have been described. Nevertheless, it will be understood that various modifications can be made without departing from the spirit and scope of the invention. Accordingly, other implementations are within the scope of the following claims.

What is claimed is:

1. A computer-implemented method comprising:
on a server, defining one or more administration groups, each administration group associated with an exclusive home folder that maps to a folder on a file system, the home folder containing one or more databases;
specifying rights of the administration group, the rights including permission to manage the databases in the home folder;
identifying a group administrator of the administration group; and
granting the group administrator the specified rights.

2. The method of claim 1, wherein subfolders of the home folder are excluded from being designated as home folder of a second administration group.

3. The method of claim 1, wherein the rights further includes permission to create new databases.

4. The method of claim 1, wherein specifying the rights comprises:
identifying a relative position of the home folder with a root folder; and
specifying rights to perform operations on the databases based on the relative position.

5. The method of claim 1, wherein the rights are applicable to the databases located in the folder of the administration group.

6. The method of claim 1, wherein identifying a group administrator comprises:
designating a group name and group password for the administration group; and
authenticating the group administrator using the group name and password.

7. The method of claim 1, wherein identifying a group administrator comprises:
defining an external group on an authentication system external to the server, the external group having an external group name;
mapping the external group to the administration group; and
designating a user as the group administrator based on a membership of the user in the external group.

8. The method of claim 7, wherein designating the user as the group administrator further comprises:
authenticating the user using the authentication system;
retrieving a collection of external groups in which the user is a member;
comparing the external groups in the collection to the administration groups on the server; and
authorizing the user to access an administration group that matches an external group.

9. The method of claim 8, further comprising:
presenting an interface for selecting a current administration group from multiple administration groups, when the multiple administration groups match the external groups in the collection;
receiving a selection of the administration current group; and
authorizing the user to access the databases referenced in the folder associated with the selected current administrative group.

10. A computer program product encoded on a computer storage medium, operable to cause data processing apparatus to perform operations comprising:
on a server, defining one or more administration groups, each administration group associated with an exclusive home folder that maps to a folder on a file system, the home folder containing one or more databases;
specifying rights of the administration group, the rights including permission to manage the databases in the home folder;
identifying a group administrator of the administration group; and
granting the group administrator the specified rights.

11. The product of claim 10, wherein subfolders of the home folder are excluded from being designated as home folder of a second administration group.

12. The product of claim 10, wherein the rights further includes permission to create new databases.

13. The product of claim 10, wherein specifying the rights comprises:
identifying a relative position of the home folder with a root folder; and
specifying rights to perform operations on the databases based on the relative position.

14. The product of claim 10, wherein the rights are applicable to the databases located in the folder of the administration group.

15. The product of claim 10, wherein identifying a group administrator comprises:
designating a group name and group password for the administration group; and
authenticating the group administrator using the group name and password.

16. The product of claim 10, wherein identifying a group administrator comprises:
defining an external group on an authentication system external to the server, the external group having an external group name;
mapping the external group to the administration group; and
designating a user as the group administrator based on a membership of the user in the external group.

17. The product of claim 16, wherein designating the user as the group administrator further comprises:
authenticating the user using the authentication system;
retrieving a collection of external groups in which the user is a member;
comparing the external groups in the collection to the administration groups on the server; and
authorizing the user to access an administration group that matches an external group.

18. The product of claim 17, further comprising:
presenting an interface for selecting a current administration group from multiple administration groups, when the multiple administration groups match the external groups in the collection;
receiving a selection of the administration current group; and
authorizing the user to access the databases referenced in the folder associated with the selected current administrative group.

19. A system comprising:
one or more computers configured to perform operations comprising:
on a server, defining one or more administration groups, each administration group associated with an exclusive home folder that maps to a folder on a file system, the home folder containing one or more databases;
specifying rights of the administration group, the rights including permission to manage the databases in the home folder;
identifying a group administrator of the administration group; and
granting the group administrator the specified rights.

20. The system of claim 19, wherein subfolders of the home folder are excluded from being designated as home folder of a second administration group.

21. The system of claim 19, wherein the rights further includes permission to create new databases.

22. The system of claim 19, wherein specifying the rights comprises:
identifying a relative position of the home folder with a root folder; and
specifying rights to perform operations on the databases based on the relative position.

23. The system of claim 19, wherein the rights are applicable to the databases located in the folder of the administration group.

24. The system of claim 19, wherein identifying a group administrator comprises:
designating a group name and group password for the administration group; and
authenticating the group administrator using the group name and password.

25. The system of claim 19, wherein identifying a group administrator comprises:
defining an external group on an authentication system external to the server, the external group having an external group name and external group password;
mapping the external group to the administration group; and
designating a user as the group administrator based on a membership of the user in the external group.

26. The system of claim 25, wherein designating the user as the group administrator further comprises:
authenticating the user using the authentication system;
retrieving a collection of external groups in which the user is a member;
comparing the external groups in the collection to the administration groups on the server; and
authorizing the user to access an administration group that matches an external group.

27. The system of claim 26, further comprising:
presenting an interface for selecting a current administration group from multiple administration groups, when the multiple administration groups match the external groups in the collection;
receiving a selection of the administration current group; and
authorizing the user to access the databases referenced in the folder associated with the selected current administrative group.
